(19) United States
(12) Patent Application Publication
(10) Pub. No.: US 2025/0344075 A1
(43) Pub. Date: Nov. 6, 2025

(54) USER ASSISTED ACCESS POINT POSITIONING

(71) Applicant: Ekahau Oy, Helsinki (FI)

(72) Inventors: Olli Alanen, Vantaa (FI); Teemu Pulkkinen, Espoo (FI); Janne Kurjenniemi, Jyväskylä (FI)

(21) Appl. No.: 18/869,774

(22) PCT Filed: Jun. 12, 2023
(86) PCT No.: PCT/FI2023/050346

§ 371 Date: Nov. 26, 2024

(30) Foreign Application Priority Data
Jun. 14, 2022 (FI) 20225529

(51) Int. Cl. H04W 16/18; H04W 24/02

(52) U.S. Cl. CPC H04W 16/18; H04W 24/02

(57) ABSTRACT

A hybrid solution for network planning is disclosed. In the hybrid solution, a computer generated network plan is displayed with at least indications of best positions for access points to be inserted. When a user input causing a change to the planning information is detected, the planning information is updated, updated indications of best positions for access points to be inserted are determined automatically, and the network plan with at least the updated indications of best positions for access points to be inserted is displayed.

### FIELD

The invention relates to radio network planning.

### BACKGROUND

A typical wireless network includes a plurality of access points providing wireless radio access. A position of each access point has a paramount importance for the operation and performance of a network, and a small change in an access point's position may have a huge impact for the operation and performance. A highly skilled person can manually place access points in a network plan, resulting to a good performance wireless network. There are also a wide variety of network planning tools available for wireless network planning and design to create network plans that automatically place access points within a planning area so that different requirements relating to the wireless network are fulfilled.

### SUMMARY

The invention relates to a method, an apparatus, a computer readable medium and a computer program defined in the independent claims. The preferred embodiments are disclosed in the dependent claims.

An aspect introduces a solution, in which a network plan indicating one or more best positions for access points, the network plan being generated by a network planning tool, is displayed to a user. A user input to the network plan may cause that the network planning tool updates indications of the best positions for access points.

### BRIEF DESCRIPTION OF THE DRAWINGS

In the following different embodiments of the invention will be described in greater detail with reference to the attached drawings, in which:

FIG. 1 illustrates an exemplified apparatus;

FIGS. 2 to 4 illustrate examples of functionalities; and

FIG. 5 is a schematic block diagram.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s)/example(s), or that the feature only applies to a single embodiment/example. Single features of different embodiments/examples may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the elements are not restricted by the terms. The terms are used merely for the purpose of distinguishing an element from other elements. For example, a first position could be termed a second position, and similarly, a second position could be also termed a first position without departing from the scope of the present disclosure.

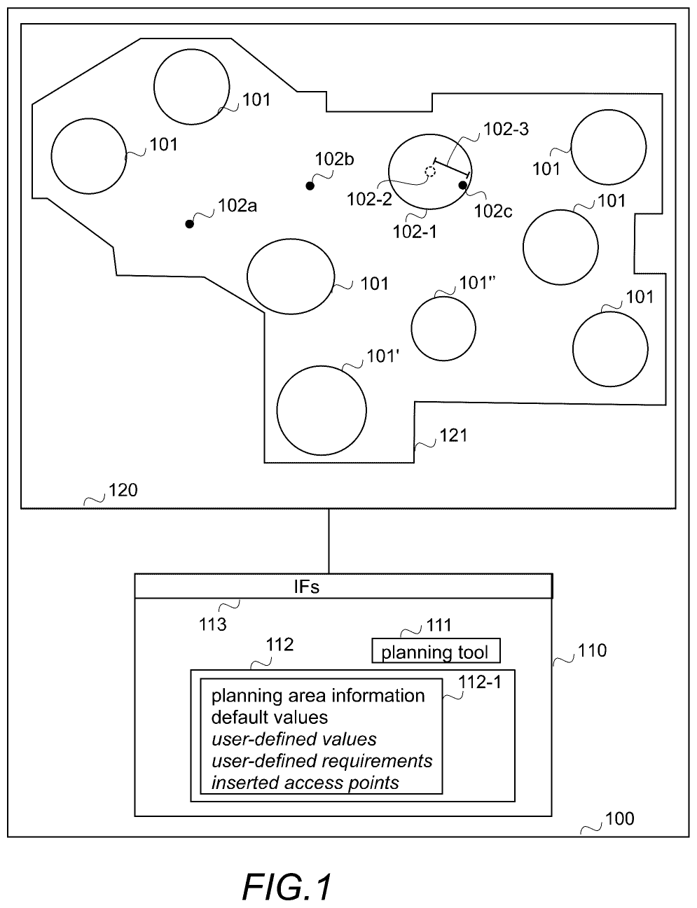

FIG. 1 illustrates a simplified apparatus describing only some logical units with their operative connections, the implementation of which may deviate from what is presented. It is obvious to a person skilled in the art that the apparatus may also comprise other functions and structures that need not be described in greater detail here, or be part of a computing environment comprising one or more apparatuses. The more detailed structure of the apparatus or a computing environment is irrelevant to the actual invention, and therefore is not described in more detail herein.

Referring to FIG. 1, the apparatus 100 may be any computing device that can be configured to run at least one network planning tool 111, i.e. at least one network planning application, that is configurable at least to determine indications of best positions for access points in a planning area, using at least received planning area information and default values for parameters, and to update the indications, when a user input received to the plan causes a change. For that purpose the apparatus 100 comprises one or more interfaces (IF)s 110 to receive user inputs, to receive planning information from one or more apparatuses, and to output the network plan, the outputting including displaying (showing) the network plan 121 to a user. The planning area is an area in which the access points are to be deployed (to form a wireless network, or part of a wireless network.)

The network planning tool 111 may be a Voronoi decomposition based tool described in U.S. Pat. No. 10,306,480 B2, which is incorporated as a reference herein. In the Voronoi decomposition based tool, the final positions of the access point are in centers of Voronoi cells.

Another example of the network planning tool 111 is a brute force approach based tool. In the brute force approach, the planning area is divided into smaller areas indicating potential access point positions. The planning area may be divided, for example, by using a simple uniform grid laid over outer boundaries of the planning area, or by using polygonal triangulation. Then all possible combinations of access point positions may be processed, including checking, per a combination, whether requirements are met or not. The requirements may be, for example, primary and secondary signal strength requirements. A non-limiting example of such requirements is based on a signal strength threshold, and requires that the signal strength or strongest (primary) access point must be above that threshold everywhere in the service area, and that the second strongest cell (secondary signal strength) must also be above the respective threshold everywhere in the service area. Access point positions are selected in the brute force approach based tool from combinations fulfilling the requirements.

It should be appreciated that the two tools described above are non-limiting examples of the network planning tool 111.

Further, the apparatus 100 comprises one or more memories (only one illustrated in FIG. 1). The memory 112 may store planning information 112-1 for a network plan. The actual detail content of the planning information 122-1 depends on a planning tool used, and received information. (The receiving covers herein also retrieving.) That having been said, usually a plurality of parameters (input parameters) are used by a planning tool. The parameter values may be default values or user-defined values, received for example by a user inputting values. The parameters may relate to access point characteristics and/or requirements relating to a wireless signal. A non-limiting list of examples of parameters that may be used include access point installation height, frequency, transmission power, antenna radiation pattern, antenna direction, access point type, access point vendor/model, client device height, signal strength threshold, received signal strength indicator limit, maximum estimated range for a predicted signal, estimated pattern directivity, minimum number of access points, maximum number of access points, and initial number of access points. (A client device is a device that will be served by an access point.)

Further, planning area information at least on outer boundaries of a planning area has to be received for the network planning tool to determine best positions for access points. The planning area information received is stored to the planning information 112-1. The planning area information received may comprise environment information, which may comprise at least one or more planning area definitions within the outer boundaries, or even outside the outer boundaries. The environment information may comprise information on propagation obstacles in the planning area, such as their dimensions and attenuation factors. For example, for a building, 3D environment information may define locations, thicknesses, materials, etc., for walls (outer walls, inside walls), floors (including roofs), windows, elevator shafts, etc. A default value for environment related parameters may be zero.

The network planning tool 111 may be configured to apply also user-defined requirements, which will be stored to the planning information 112-1. A user-defined requirement may be an additional condition to preconfigured conditions (requirements), or a complement to a preconfigured condition. An example of a user-defined requirement is a minimum distance between access points. Another example is a minimum distance of an access point to a wall.

Naturally, information on any inserted access point, i.e. any access point placed by a user to a position, is stored to the planning information 112-1.

The apparatus also comprises one or more display devices 120 (only one illustrated in FIG. 1). A display device may be any kind of a screen or other display unit providing a graphical user interface, either external to the apparatus or integrated to the apparatus. A non-limiting examples of such display devices include different screens, like a touchscreen, a see-through screen, a display screen, a projection screen, wearable screen, like a virtual reality headset, and monitors, like a computer monitor and a portable display monitor. Naturally there may be other interfaces for user inputs, like keypads, memory sticks, etc.

In the example of FIG. 1, it is assumed that some user inputs has been received, and the network plan 121, or shortly plan, shown (displayed) to a user on the display device 120 is an updated network plan. In the illustrated example, the outer boundaries of the planning area are displayed, access points 102a, 102b inserted by a user to in corresponding positions are shown by black dots, and indications of best positions for access points are indicated by circles 101, 101′, 101″, which may be of different size. In the illustrated example, the user is inserting an access point 102c within an indication 102-1 of the best positions, but at a distance 102-3 from the best position 102-2.

It should be appreciated that any way to indicate best positions may be used. For example, the indication may be similar to a combination of the best position 102-2 and the indication 102-1, i.e. to indicate the best position, and a good/very good area around it. In another example, the indication may be the mere indication 102-2 of the best position, indicated for example using different color than what is used to show (user-defined) inserted (final) positions. Further non-limiting examples include using different colors, for example the darker the color, the better the area, using animations, bolding, etc. Further, different indications may be used in different areas. For example, a whole room to which an access point should be placed according to the network planning application, may be highlighted or colored, whereas in other areas circles may be used as indications.

The apparatus 100 illustrated in FIG. 1 represents one example which may be implemented by one apparatus. Non-limiting examples of such apparatuses include a dedicated server, a distributed computing device that may use cloud computing or grid computing, and a user terminal or a workstation, such as a laptop, a smartphone, a personal computer, a tablet computer, a field device, augmented reality equipment, and virtual reality equipment.

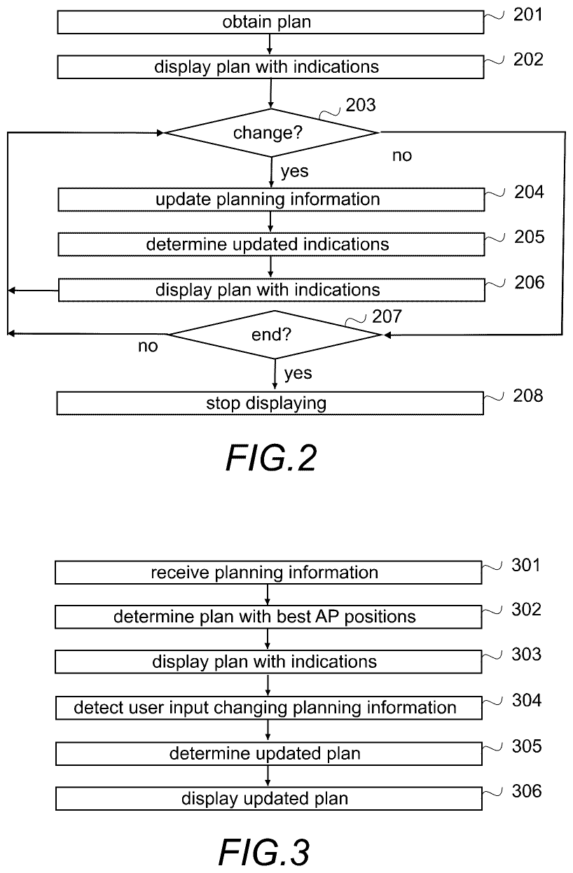

FIG. 2 is a flow chart illustrating an exemplified functionality of a network planning tool configured to automatically determine (create or generate) a network plan with indications of best positions for access points, i.e. for access points to be inserted, and then allowing a continued human-machine interaction process by updating the indications responsive to user input, the end result being a wireless radio network plan generated by combining advantages provided by network planning tool and advantages provided by a human mind.

Referring to FIG. 2, a network plan comprising one or more indications of best positions for access points in a planning area is obtained in step 201. The obtaining covers herein creating a network plan by the network planning tool and retrieving from the memory an earlier created, possibly updated network plan. In both cases, the one or more indications of best positions have been determined by the network planning tool using the planning information. As described above, the planning information comprises parameter values and received planning area information on at least outer boundaries of a planning area. Further, the network planning tool uses a default value of a parameter when there is no user-defined value for the parameter in the planning information.

The obtained network plan with at least the indications of best positions for access points to be inserted is displayed in step 202. An access point to be inserted means herein an access point automatically positioned by the network planning tool but not yet placed (inserted) by the user, the user making the final decision on the positions. Hence, the network plan thus created can be seen as a network plan checked and approved by a user.

The network planning tool monitors user inputs. When a user input causing a change to the planning information is detected (step 203: yes), the planning information is updated in step 204 correspondingly, the result being an updated planning information. A user input causing a change may be a user input placing a first access point to a first position, or a user input changing a place of the first access point from the first position to a second position, a user input removing (deleting) the first access point, a user input replacing at least one first value (a default value or a user-defined value) by a second value, a user input defining a first requirement, or a user input loading updated planning area information.

Then the network planning tool automatically determines in step 205, using the updated planning information, updated indications of best positions for access points to be inserted. It should be appreciated that the end result may be that there is no need to insert any further access points, in which case there will be no indication of best positions. The network plan is displayed, i.e. shown to the user, in step 206 with at least the updated indications of best positions for access points to be inserted. If there are inserted access points, they are also displayed, and at the end it may be that no indications are displayed, and the network plan thus obtained is ready to be used for installing access points according to the plan.

Then the process returns to step 203 to monitor user inputs, until a user input to end processing the network plan is received (step 207), after which the network plan is not any more displayed (step 208). The updated planning information may be stored to the memory when the user input to end processing is received, or at any time during the processing.

FIG. 3 illustrates another example functionality. Referring to FIG. 3, planning information is received in step 301 and a network plan with best access point (AP) positions is automatically determined in step 302, and displayed in step 303 with indications for best positions for access points. When a user input changing the planning information is received in step 304, an updated plan is determined automatically in step 305, and the updated plan is displayed in step 306. Although not illustrated, steps 304, 305, and 306 may be repeated multiple times. Determining an updated plan includes updating planning information.

FIG. 4 illustrates an example functionality, describing in more detail what may performed in steps 204 to 206 in FIG. 2 or in steps 304 to 306 in FIG. 3.

Referring to FIG. 4, the process monitors (step 401), whether a user input causing a change to a network plan is received, and when such a user input is received (step 401: yes), it determines the type of the change.

If the user input is a user input placing (inserting) an access point, AP, to a first position (step 402: yes), in the illustrated example it is determined in step 403, whether the first position is one of the best positions displayed. For example, using the example of FIG. 1, it is determined whether the position 102c is the best position 102-2. Naturally, planning information is updated to have an inserted access point in the first position.

If the first position, i.e. the user-defined position, is the best position (step 403: yes), the process updates in step 404 the displayed plan by replacing the indication of the best position by an inserted access point and continues displaying other current indications of best positions for the remaining access points to be inserted. Then the process continues in step 401 monitoring user inputs.

If the first position is not one of the best positions displayed (step 403: no), as is the case in the example of FIG. 1, in the illustrated example it is checked in step 405, whether there is a requirement relating to maximum number of access point and if there is, whether the inserted access point is the last access point that can be inserted and yet the requirement is fulfilled. If there was the requirement and the access point was the last to be inserted (step 405: yes), in the illustrated example, the process continues to step to update the displayed plan by replacing the indication of the best position by an inserted access point at the user-defined positions and continues displaying the plan with inserted access points, thereby allowing the user further modify the plan. In another implementation, the process may continue to step 406 and the network planning tool may be configured to display possible indications with a further indication that maximum number will be exceeded to have proper coverage, for example by using a different color for the indication than for the earlier indications. In a further implementation, the checking in step 405 is omitted, i.e. the process does not contain such a checking.

If before insertion of the access point two or more indications of best positions were displayed (step 405: no), an updated plan with updated indications is determined in step 406. In other words, the network planning tool is re-run in step 406. To determine the updated plan automatically, the network planning tool is configured so that all inserted access points remain in their positions and preferably, but not necessarily, no indications will be placed in their serving area, otherwise the determining is performed as if no existing plan exists. For example, the Voronoi decomposition based network planning tool may be configured to map, per an inserted access point, the position to one of Voronoi cells, and to blacklist that area. Blacklisting the area ensures that indications of best positions are in areas that do not have access points installed. The brute force based network planning tool may be configured to include in all sets evaluated the inserted access point(s) and to display them as inserted access point(s) instead of a corresponding indications. After the updated plan is determined in step 406, it will be displayed in step 407. Assuming that not all access point have been inserted and one or more access points have been inserted, the inserted access point(s) in its/their positions and updated indications of best positions for the remaining access points to be inserted are displayed in step 407 in the updated plan.

If an access point is moved (step 408: yes), the process proceeds to step 406 to determine the updated plan to correspond to the new position of the access point. The Voronoi decomposition based tool may be configured to update blacklisting of areas, for example by deleting blacklisting of the area of the previous position and map the new position to one of Voronoi cells, and blacklist that area. Naturally, the planning information is updated by replacing the earlier position with the new position.

If an access point is removed (step 409: yes), the process proceeds to step 406 to determine the updated plan. The updated plan may comprise an indication of best position corresponding to the position of the removed access point. The Voronoi decomposition based tool may be configured to update blacklisting of areas, for example by deleting blacklisting of the area mapped to the removed access point. Naturally the planning information is updated by deleting the insertion of the first access point.

If the user input defines (step 410: yes) a requirement, the process proceeds to step 406 to determine an updated plan fulfilling the requirement, the updated plan comprising updated indications of best positions for access points to be inserted. Naturally, the planning information is updated to comprise the requirement.

If the user input is an update to the planning area information (step 411: yes), for example environment information is loaded or a place of a wall changed, or outer boundaries are changed, the process proceeds to step 406 to determine an updated plan according to the updated planning area information. The displayed network plan may show, in addition to the updated indications, also updated area. Naturally, the planning information is updated to comprise the update.

If the user input is not any of the above described inputs, in the illustrated example it is assumed that the user input relates to parameter values, i.e. is a user input replacing at least one first value by a second value. Therefore in the illustrated example it is checked in step 412, whether the first value, i.e. the value to be replaced, is a default value.

If the second value is replacing a user-defined value (step 412: no), the process proceeds to step 406 to determine an updated plan using for the parameter the second value instead of the first value. Naturally, the planning information is updated to comprise the second value as the user-defined value for the parameter. In other words, the first value is replaced by the second value.

If the first value is a default value (step 412: yes), in the illustrated example the process is configured to determine in step 413, whether the second value is inputted as a value to be shared by all access points, or as a value for one access point, or as a value for a subset of access points.

If the value is to be shared by all access points (step 413: yes), the process proceeds to step 406 to determine an updated plan using for the parameter the second value instead of the default value. Naturally, the planning information is updated to comprise the second value as the user-inserted value for the parameter. Depending on an implementation, the default value may be maintained or replaced by the second value.

If the value is for one access point or for a subset of access points (step 413: no), the planning information is updated in step 414 to comprise the second value for the one access point or for the subset of access points while the default value will be used for other access points. The process then proceeds to step 406 to determine an updated plan using for the parameter both the default value and the second value, according to the updated planning information. It should be appreciated that herein the access point may be an inserted access points, or an access point to be inserted. The network planning tool is preferably configured to allow a user to select an area or a plurality of indications (and inserted access points) to input a value for one or more access points inserted and/or to be inserted. For example, a user may select a room in which access point installation height is different than in other rooms, and then the network planning tool applies this to access points installed in the room or to be installed in the room. Another example is that the access point installation height for inserted access point may remain to be the default value, i.e. the value to be used with access points already installed, but when the network planning tool is re-run in step 406, the user-defined value is used when indications of the best positions are determined, and the user-defined value is hence used for access points installed (and to be installed) after re-running the network planning tool.

As can be seen from the above examples, a hybrid network planning combining manual and automatic network planning provides assistance to a human (user) planning the network, the network planning tool guiding the human towards a best solution, taking into account different signal strength requirements that are not so easy for a human, based on human's user input(s). In a similar manner, the hybrid network planning provides assistance to the network planning tool by allowing the human to take care, for example, of details that are inherently difficult to be included to be solved by network planning tool. Hence, the final network plan may be obtained faster, it may be more accurate and more practical compared to existing non-hybrid solutions. A network built up according to such a network plan requires less tuning after it has been deployed (installed), thanks to optimal access point placements and configurations provided by the hybrid network planning disclosed herein.

As is evident from the above, the present invention is applicable to be used with any wireless radio network planning application for planning wireless networks. The type of the wireless networks is irrelevant. For example, one or more plans may be for a network according to fifth generation (5G) system, beyond 5G, and/or wireless networks based on IEEE 802.xx specifications, such as IEEE 802.11 (WLAN) and IEEE 802.15, or any combination thereof. 5G has been envisaged to use a so-called small cell concept including macro sites operating in co-operation with smaller local area access points (access nodes), including mobile access nodes, and also employing a variety of radio technologies, for example incorporating both cellular (3GPP) and non-cellular (e.g. IEEE) technologies.

The steps and related functions described above in FIGS. 2 to 4 are in no absolute chronological order, and some of the steps/related functions may be performed simultaneously or in an order differing from the given one. Other functions can also be executed between the steps or within the steps. Some of the steps or part of the steps can also be left out or replaced by a corresponding step or part of the step or information exchange. For example, step 403 and 404 may be omitted (as well as step 405), resulting that the network planning tool is re-run. Further, the described processes and steps within processes, may run in parallel.

The techniques and methods described herein may be implemented by various means so that an apparatus/equipment/a device configured to provide the network planning tool, or to perform re-run according to at least partly on what is disclosed above with any of FIGS. 1 to 4, including implementing one or more functions/operations described above with an embodiment/example, for example by means of any of FIGS. 1 to 4, comprises not only prior art means, but also means for implementing the one or more functions/operations of a corresponding functionality described with an embodiment/example, for example by means of any of FIGS. 1 to 4, and the apparatus may comprise separate means for each separate function/operation, or means may be configured to perform two or more functions/operations. Apparatuses (devices, equipments) may generally include one or more processors, controllers, control units, micro-controllers, or the like connected to one or more memories and to various interfaces of the apparatus, configured to implement the network planning tool or the re-run of the network planning tool. For example, one or more of the means and/or any tool described above may be implemented in hardware (one or more devices), firmware (one or more devices), software (one or more modules), or combinations thereof.

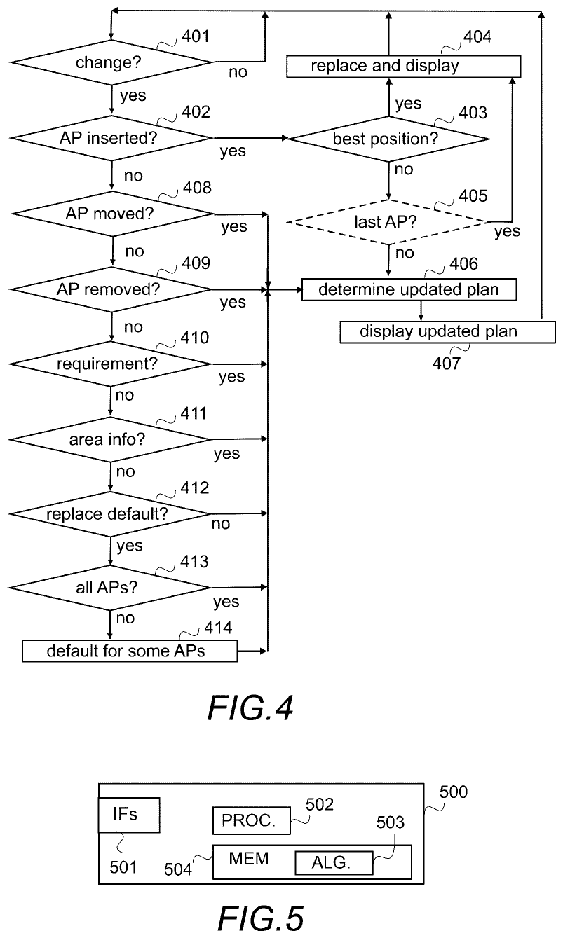

FIG. 5 is a simplified block diagram illustrating some units for an apparatus 500 configured to provide the functionality described above with FIGS. 1 to 4, comprising at least the network planning tool with the re-run functionality (assisting functionality), or an apparatus 500 comprising some of the corresponding functionality if functionalities are distributed in the future.

Referring to FIG. 5, the apparatus 500 comprises one or more interfaces (IFs) 801 for retrieving (obtaining) for example planning information. The one or more interfaces comprise one or more user interfaces for user interaction. The apparatus 500 further comprises one or more processors 502 configured to implement the functionality described above with FIGS. 1 to 4, or at least part of corresponding functionality as a sub-unit functionality if a distributed scenario is implemented, with corresponding algorithms 503, and one or more memories 504 usable for storing a computer program code required for the functionality of the apparatus, including the network planning tool, i.e. the algorithms for implementing the functionality. The memory 504 is also usable for storing other information, such as the planning information.

Generally a processor 502 is a central processing unit, but the processor may be an additional operation processor. The network planning tool and/or algorithms described herein may be configured as a computer or a processor, or a microprocessor, such as a single-chip computer element, or as a chipset, including at least a memory for providing storage area used for arithmetic operation and an operation processor for executing the arithmetic operation. The one or more processors may comprise one or more computer processors, application-specific integrated circuits (ASIC), digital signal processors (DSP), digital signal processing devices (DSPD), programmable logic devices (PLD), field-programmable gate arrays (FPGA), graphics processing units (GPUs), logic gates and/or other hardware components that have been programmed and/or will be programmed by downloading computer program code (one or more algorithms) in such a way to carry out one or more functions described above. An embodiment provides a computer program embodied on any client-readable distribution/data storage medium or memory unit(s) or article(s) of manufacture, comprising program instructions executable by one or more processors/computers, which instructions, when loaded into an apparatus/device, constitute the network planning tool, or a plugin, for example, to an existing network planning tool. Programs, also called program products, including software routines, program snippets constituting “program libraries”, applets and macros, can be stored in any medium and may be downloaded into an apparatus. In other words, each or some or one of the tools and/or the algorithms described above may be an element that comprises one or more arithmetic logic units, a number of special registers and control circuits.

The memory 504 may generally include volatile and/or non-volatile memory, for example EEPROM, ROM, PROM, RAM, DRAM, SRAM, double floating-gate field effect transistor, firmware, programmable logic, etc. and typically store content, data, or the like. In other words, the one or more memories 504 may be of any type (different from each other), have any possible storage structure and, if required, being managed by any database management system. It is to be noted that the memory, or part of it, may be any computer-usable non-transitory medium within the processor/apparatus or external to the processor/apparatus, in which case it can be communicatively coupled to the processor/apparatus via various means as is known in the art. Examples of an external memory include a removable memory detachably connected to the apparatus, a distributed database and a cloud. The memory may also store computer program code such as software applications (for example, for one or more of the tools) or operating systems, information, data, content, or the like for the processor to perform steps associated with operation of the apparatus in accordance with examples/embodiments.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A computer implemented method comprising:
obtaining a network plan comprising one or more indications of best positions for access points in a planning area, wherein the one or more indications of best positions have been determined by a network planning tool using planning information comprising parameter values and received planning area information on at least outer boundaries of a planning area, wherein a default value of a parameter is used when there is in the planning information no user-defined value for the parameter;
displaying the network plan with at least the indications of best positions for access points to be inserted, wherein an access point to be inserted is an access point positioned automatically by the network planning tool but not yet inserted to the network plan by a user input placing an access point to a position in the network plan;
updating, in response to detecting a user input causing a change to the planning information, the planning information correspondingly to updated planning information;
determining, in response to said user input, using the updated planning information, updated indications of best positions for access points to be inserted while maintaining access points inserted to the network plan in their positions; and
displaying the network plan with at least the updated indications of best positions for access points to be inserted.

2. The computer implemented method of claim 1, wherein the user input causing a change to the planning information is a user input placing a first access point to a first position, and the method further comprises:
updating the planning information by inserting the first access point to the first position;
determining, using the updated planning information, updated indications of best positions for remaining access points to be inserted; and
displaying the network plan with at least the first access point in the first position and the updated indications of best positions for the remaining access points to be inserted.

3. The computer implemented method of claim 2, further comprising, prior to determining the updated indications of best positions:
determining, whether the first position is one of the best positions, in response to the first position being one of the best positions, using current indications of best positions for the remaining access points to be inserted as the updated indications; and
in response to the first position not being one of the best positions, performing the determining of the updated indications of best positions for access points to be inserted.

4. The computer implemented method of claim 2, wherein the user input causing a change to the planning information is a user input changing a place of the first access point from the first position to a second position, and the method further comprises:
updating the planning information by moving in the plan the first access point to the second position;
determining, using the updated planning information, updated indications of best positions for the access points to be inserted; and
displaying the network plan with at least the first access point in the second position and the updated indications of best positions for the access points to be inserted.

5. The computer implemented method of claim 2, wherein the user input causing a change to the planning information is a user input removing the first access point, and the method further comprises:
updating the planning information by deleting the insertion of the first access point;
determining, using the updated planning information, updated indications of best positions for the access points to be inserted; and
displaying the network plan with the updated indications of best positions for the access points to be inserted.

6. The computer implemented method of claim 1, wherein the user input causing a change to the planning information is a user input replacing at least one first value by a second value, and the method further comprises:
updating the planning information to comprise the second value as a user-defined value for a first parameter; and
determining, using the second value instead of the at least one first value, updated indications of best positions for access points to be inserted.

7. The computer implemented method of claim 6, further comprising, prior to updating, when the first parameter relates to access point characteristics:
checking, whether the first value is a default value;
in response to the first value not being a default value, updating the planning information by replacing the at least one first value with the second value;
in response to the first value being a default value, performing the following:
determining, whether the second value is inputted as a value to be shared by all access points, or as a value for one access point, or as a value for a subset of access points;
updating, in response to the value to be shared by all access points, the planning information to comprise the second value instead of the default value;
updating, in response to the value being for one access point or for a subset of access points, the planning information to comprise the second value for the one access point or for the subset of access points and the default value for remaining access points.

8. The computer implemented method of claim 1, wherein the user input causing a change to the planning information is a user input defining a first requirement, and the method further comprises:
updating the planning information to comprise the first requirement;
determining, using the updated planning information with the first requirement, updated indications of best positions for the access points to be inserted.
determining, using at least the planning information and the first requirement, an updated plan comprising updated indications of best positions for access points to be inserted; and
displaying the updated plan at least with the indications of at least best positions for access points to be inserted.

9. The computer implemented method of claim 1, wherein the user input causing a change to the planning information is a user input loading updated planning area information, and the method further comprises:
updating the planning area information in the planning information correspondingly;
determining, using the updated planning information, updated indications of best positions for the access points to be inserted; and
displaying the network plan according to the updated planning area information with at least the updated indications of best positions for the access points to be inserted.

10. The computer implemented method of claim 1, wherein the plurality of the parameters comprises one or more of a transmission power, frequency, access point installation height, antenna radiation pattern, antenna direction, access point vendor/model, client device height and signal strength threshold.

11. (canceled)

12. A non-transitory computer readable medium comprising instructions which, when executed by an apparatus, cause the apparatus to at least carry out:
obtaining a network plan comprising one or more indications of best positions for access points in a planning area, wherein the one or more indications of best positions have been determined by a network planning tool using planning information comprising parameter values and received planning area information on at least outer boundaries of a planning area, wherein a default value of a parameter is used when there is in the planning information no user-defined value for the parameter;
displaying the network plan with at least the indications of best positions for access points to be inserted, wherein an access point to be inserted is an access point positioned automatically by the network planning tool but not yet inserted to the network plan by a user input placing an access point to a position in the network plan;
updating, in response to detecting a user input causing a change to the planning information, the planning information correspondingly to updated planning information;
determining, in response to said user input, using the updated planning information, updated indications of best positions for access points to be inserted while maintaining access points inserted to the network plan in their positions; and
displaying the network plan with at least the updated indications of best positions for access points to be inserted.

13. (canceled)

14. (canceled)

15. (canceled)

16. An apparatus comprising at least one processor, and at least one memory including computer program code stored thereon which, when executed by at least one of the at least one processor, cause the apparatus at least to:
obtain a network plan comprising one or more indications of best positions for access points in a planning area, wherein the one or more indications of best positions have been determined by a network planning tool using planning information comprising parameter values and received planning area information on at least outer boundaries of a planning area, wherein a default value of a parameter is used when there is in the planning information no user-defined value for the parameter;
display the network plan with at least the indications of best positions for access points to be inserted, wherein an access point to be inserted is an access point positioned automatically by the network planning tool but not yet inserted to the network plan by a user input placing an access point to a position in the network plan;
update, in response to detecting a user input causing a change to the planning information, the planning information correspondingly to updated planning information;
determine, in response to said user input, using the updated planning information, updated indications of best positions for access points to be inserted while maintaining access points inserted to the network plan in their positions; and
display the network plan with at least the updated indications of best positions for access points to be inserted.

17. The apparatus of claim 16, wherein the computer program code, when executed, further cause, when the user input causing a change to the planning information is a user input placing a first access point to a first position, the apparatus to:
update the planning information by inserting the first access point to the first position;
determine, using the updated planning information, updated indications of best positions for remaining access points to be inserted; and
display the network plan with at least the first access point in the first position and the updated indications of best positions for the remaining access points to be inserted.

18. The apparatus of claim 17, wherein the computer program code, when executed, further cause, prior to determining the updated indications of best positions, the apparatus to:
determine, whether the first position is one of the best positions,
in response to the first position being one of the best positions, use current indications of best positions for the remaining access points to be inserted as the updated indications; and
in response to the first position not being one of the best positions, perform determining of the updated indications of best positions for access points to be inserted.

19. The apparatus of claim 17, wherein the computer program code, when executed, further cause, the user input causing a change to the planning information is a user input changing a place of the first access point from the first position to a second position, the apparatus to:
update the planning information by moving in the plan the first access point to the second position;
determine, using the updated planning information, updated indications of best positions for the access points to be inserted; and
display the network plan with at least the first access point in the second position and the updated indications of best positions for the access points to be inserted.

20. The apparatus of claim 17, wherein the computer program code, when executed, further cause, when the user input causing a change to the planning information is a user input removing the first access point, the apparatus to:
update the planning information by deleting the insertion of the first access point;
determine, using the updated planning information, updated indications of best positions for the access points to be inserted; and
display the network plan with the updated indications of best positions for the access points to be inserted.

21. The apparatus of claim 16, wherein the computer program code, when executed, further cause, when the user input causing a change to the planning information is a user input replacing at least one first value by a second value, the apparatus to:
update the planning information to comprise the second value as a user-defined value for a first parameter; and
determine, using the second value instead of the at least one first value, updated indications of best positions for access points to be inserted.

22. The apparatus of claim 21, wherein the computer program code, when executed, further cause, prior to updating, when the first parameter relates to access point characteristics, the apparatus to:
check, whether the first value is a default value;
in response to the first value not being a default value, update the planning information by replacing the at least one first value with the second value;
in response to the first value being a default value, perform the following:
determining, whether the second value is inputted as a value to be shared by all access points, or as a value for one access point, or as a value for a subset of access points;
updating, in response to the value to be shared by all access points, the planning information to comprise the second value instead of the default value;
updating, in response to the value being for one access point or for a subset of access points, the planning information to comprise the second value for the one access point or for the subset of access points and the default value for remaining access points.

23. The apparatus of claim 16, wherein the computer program code, when executed, further cause, when the user input causing a change to the planning information is a user input defining a first requirement, the apparatus to:
update the planning information to comprise the first requirement;
determine, using the updated planning information with the first requirement, updated indications of best positions for the access points to be inserted.
determine, using at least the planning information and the first requirement, an updated plan comprising updated indications of best positions for access points to be inserted; and
display the updated plan at least with the indications of at least best positions for access points to be inserted.

24. The apparatus of claim 16, wherein the computer program code, when executed, further cause, when the user input causing a change to the planning information is a user input loading updated planning area information, the apparatus to:
update the planning area information in the planning information correspondingly;
determine, using the updated planning information, updated indications of best positions for the access points to be inserted; and
display the network plan according to the updated planning area information with at least the updated indications of best positions for the access points to be inserted.
